(19) United States
(12) Patent Application Publication
(10) Pub. No.: US 2026/0044202 A1
(43) Pub. Date: Feb. 12, 2026

(54) INFORMATION PROCESSING DEVICE, INFORMATION PROCESSING METHOD, AND PROGRAM

(71) Applicant: Sony Group Corporation, Tokyo (JP)

(72) Inventor: Yoshinori OHASHI, Tokyo (JP)

(73) Assignee: Sony Group Corporation, Tokyo (JP)

(21) Appl. No.: 18/998,865

(22) PCT Filed: Jul. 27, 2023
(86) PCT No.: PCT/JP2023/027523

§ 371 Date: Jan. 27, 2025

(30) Foreign Application Priority Data
Aug. 10, 2022 (JP) 2022-128047

(51) Int. Cl. G06F 3/01

(52) U.S. Cl. CPC G06F 3/011

(57) ABSTRACT

An information processing device according to the present technology includes a motion data conversion unit that receives an input of captured motion data that is motion data acquired with a motion capture system for a movable object, and performs a motion data conversion process to obtain motion data having a larger number of pieces of part data than the captured motion data, through one of a motion matching process based on the captured motion data or an inference process that uses an artificial intelligence model and uses the captured motion data as input data.

### TECHNICAL FIELD

The present technology relates to an information processing device, an information processing method, and a program, and more particularly, to a technology for converting motion data obtained by motion capture of a movable object into high-quality motion data including a larger number of parts.

### BACKGROUND ART

For example, there is a demand for capturing movement of a player in a sports game or the like such as a soccer or baseball game, and viewing the movement in a free viewpoint image.

At this point, it is difficult to apply a capture technique with a high capture cost such as OptiTrack in a real professional sports game, because a marker needs to be attached to each player. On the other hand, application of a relatively low-cost motion capture system using images captured by a camera is also conceivable. In that case, however, it is difficult to capture minute parts such as finger joints, for example, and motion data has only low quality, resulting in a problem that realism is lost when a player's movement is reproduced as a free viewpoint image. This is because, in a case where a sports game is captured with a markerless motion capture system using a camera, it is difficult to cause the camera to always follow each player, and there is a limit in recognition accuracy even if the whole scene is captured with a plurality of cameras.

Therefore, attempts have been made to increase the quality of motion data by estimating parts that have not been captured in the motion data acquired with a low-cost motion capture system.

For example, Patent Document 1 listed below discloses a technique for calculating a joint angle by calculation using forward kinematics (FK) and inverse kinematics (IK) for motion data. Also, Patent Document 2 listed below discloses a technique for estimating the positions, postures, or motion of other parts closer to the center of the body than the target part, on the basis of feature data indicating the features of time-series transition of motion data.

### CITATION LIST

### Patent Document

PATENT DOCUMENT 1 Japanese Patent Application Laid-Open No. 2004-078695
PATENT DOCUMENT 2 WO 2020/049847 A

### SUMMARY OF THE INVENTION

### Problems to be Solved by the Invention

However, neither of Patent Documents 1 and 2 mentioned above discloses a case where the position and posture (orientation) of a part on the peripheral side is calculated from the center side, the part being a portion to which IK is unapplicable, such as a case where the joints of fingers are calculated from the hand.

Note that, in estimating the joints of the fingers from the hand, it is conceivable to adopt a technique of always adopting the same posture for the fingers or the like, taking rotation of the hand into consideration. In that case, the posture of the fingers is always the same, and therefore, the posture of the fingers cannot be appropriately changed depending on the situation in which the target movable object such as a player is placed.

The present technology has been made in view of the above circumstances, and aims to acquire high-quality motion data at low cost by eliminating the need to use a high-precision motion capture system capable of capturing parts on the peripheral side in obtaining high-quality motion data including part information on the peripheral side, such as joint information about the fingers of the hands.

### Solutions to Problems

An information processing device according to the present technology includes a motion data conversion unit that receives an input of captured motion data that is motion data acquired with a motion capture system for a movable object, and performs a motion data conversion process to obtain motion data having a larger number of pieces of part data than the captured motion data, through a motion matching process based on the captured motion data or an inference process that uses an artificial intelligence model and uses the captured motion data as input data.

As described above, by performing a process of conversion into motion data having a large number of pieces of part data through a motion matching process or an inference process using an artificial intelligence model, it is possible to obtain the motion data on the peripheral side from the motion data on the center side of the object.

### BRIEF DESCRIPTION OF DRAWINGS

FIG. 1 is a block diagram illustrating an example configuration of a motion data conversion system as a first embodiment according to the present technology.

FIG. 2 is a block diagram illustrating an example of the hardware configuration of an information processing device as an embodiment.

FIG. 3 is an explanatory diagram of an example configuration for implementing a motion data conversion technique as the first embodiment.

FIG. 4 is a diagram illustrating a concept image of a motion data table group.

FIG. 5 is a diagram for explaining an effect of a motion data conversion process as the first embodiment.

FIG. 6 is also a diagram for explaining an effect of a motion data conversion process as the first embodiment.

FIG. 7 is also a diagram for explaining an effect of a motion data conversion process as the first embodiment.

FIG. 8 is also a diagram for explaining an effect of a motion data conversion process as the first embodiment.

FIG. 9 is a flowchart showing an example of processing procedures for implementing the motion data conversion technique as the first embodiment.

FIG. 10 is a block diagram illustrating an example configuration of a motion data conversion system as a second embodiment.

FIG. 11 is an explanatory diagram of functions of an information processing device as the second embodiment.

FIG. 12 is an explanatory diagram of machine learning for obtaining a trained AI model according to the second embodiment.

FIG. 13 is a diagram illustrating an example configuration of a learning machine to be used in the machine learning according to the second embodiment.

FIG. 14 is a block diagram illustrating an example configuration of a motion data conversion system as a third embodiment.

FIG. 15 is an explanatory diagram of functions of a server device and each user terminal according to the third embodiment.

FIG. 16 is a diagram for explaining an example of machine learning of a motion data inference model taking interactions between users into consideration.

FIG. 17 is a diagram illustrating an example configuration of a learning machine to be used in the machine learning of a motion data inference model taking interactions between users into consideration.

### MODE FOR CARRYING OUT THE INVENTION

In the description below, embodiments according to the present technology will be explained in the following order, with reference to the accompanying drawings.
<1. First Embodiment>
(1-1. System Configuration)
(1-2. Hardware Configuration of an Information Processing Device)
(1-3. Motion Data Conversion Technique as the First Embodiment)
(1-4. Processing Procedures)
<2. Second Embodiment>
<3. Third Embodiment>
<4. Modifications>
<5. Summary of the Embodiments>
<6. Present Technology>
<1. First Embodiment>

### 1-1. System Configuration

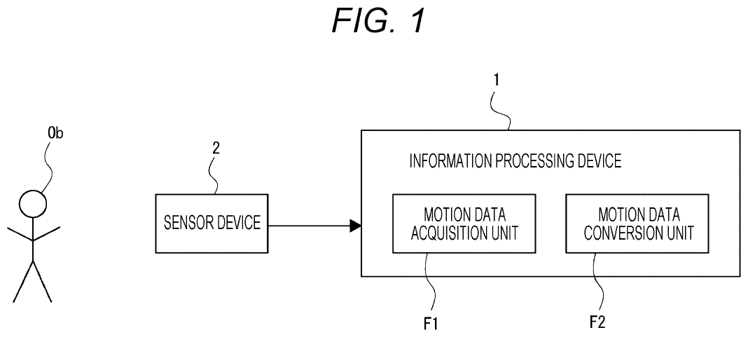

FIG. 1 is a block diagram illustrating an example configuration of a motion data conversion system as a first embodiment according to the present technology.

The motion data conversion system according to the embodiment acquires motion data of a movable object Ob by performing motion capture on the movable object Ob as the target such as a person, for example, and converts the motion data into motion data including a larger number of pieces of part data.

Here, “motion data” in the present specification corresponds to data of a so-called skeleton model (skeletal model), and means data indicating at least the three-dimensional positions of a plurality of specific parts such as joints in the target movable object Ob. In the present embodiment, motion data is data indicating the three-dimensional positions and orientations of a plurality of specific parts of the movable object Ob.

Further, a movable object broadly means an object that can move. However, a movable object is not limited to a living object such as a human or an animal, and may be a non-living object such as a robot, for example.

In the following description of the embodiment, a case based on the assumption that movement of a person related to a sports game such as soccer, basketball, or baseball, for example, is reproduced by a three-dimensional model will be described. In this case, the movable object Ob to be the target of the motion capture may be a movable object present on the field where the game is being played, such as a person as a player, or a person as a referee.

As illustrated in the drawing, the motion data conversion system as the first embodiment includes an information processing device 1 and a sensor device 2.

The sensor device 2 represents one or a plurality of sensors to be used for motion capture. In this example, a markerless method is adopted as the motion capture method, and the sensors included in the sensor device 2 include at least an image sensor for obtaining a captured image of the movable object Ob. Specifically, in this example, a kinect method is adopted as the motion capture method, and a device including an image sensor (RGB camera) of red, green, and blue (RGB) and a time of flight (ToF) sensor is used as the sensor device 2.

The information processing device 1 is formed with a computer device including a central processing unit (CPU), a read only memory (ROM), a random access memory (RAM), and the like, for example, and performs a process of converting motion data on the basis of sensing data from the sensor device 2. As illustrated in the drawing, the information processing device 1 has functions as a motion data acquisition unit F1 and a motion data conversion unit F2.

The motion data acquisition unit F1 performs a process of acquiring motion data of the movable object Ob, on the basis of the sensing data from the sensor device 2.

Specifically, the motion data acquisition unit F1 of this example performs a process of calculating motion data indicating the position and orientation of each specific part of the movable object Ob, on the basis of a captured image of the movable object Ob and a depth image obtained through a distance measuring operation on the movable object Ob, which are obtained by the RGB camera and the ToF sensor in the sensor device 2, respectively. Here, a markerless method is adopted as the motion capture method in this example. Therefore, the motion data acquired by the motion data acquisition unit F1 is relatively low quality data, and the motion data of the finger portions of the hands is not acquired. Specifically, motion data of the joint portions and the tips of the respective fingers of the hands is not acquired.

The motion data conversion unit F2 performs a process of converting the motion data acquired by the motion data acquisition unit F1 (this data will be hereinafter referred to as “captured motion data”) into motion data having a larger number of pieces of part data. In the first embodiment, the motion data conversion process is performed through a motion matching process, and details thereof will be described later.

Note that, although FIG. 1 illustrates an example configuration in which the sensor device 2 is a device separated from the information processing device 1, a configuration in which the sensor device 2 is integrated with the information processing device 1 may also be adopted.

### 1-2. Hardware Configuration of the Information Processing Device

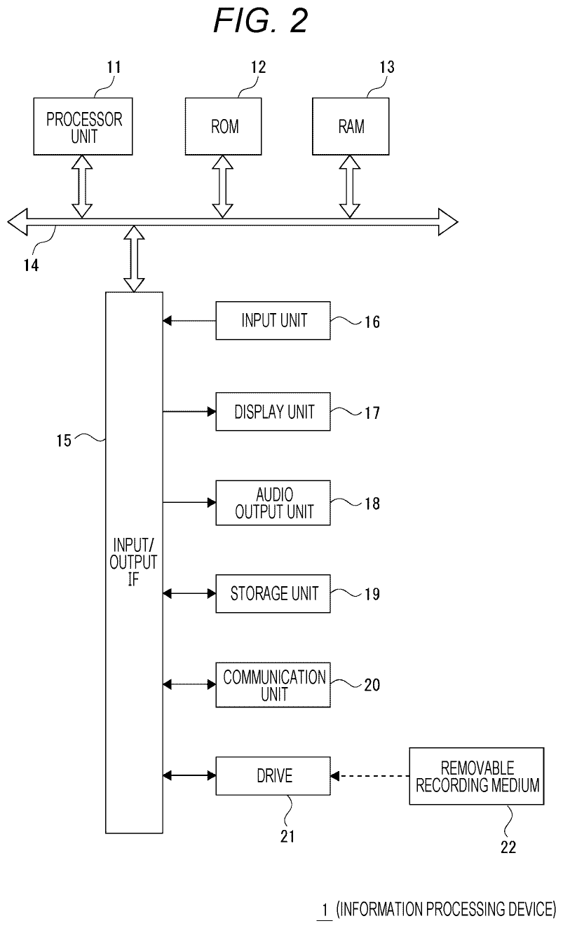

FIG. 2 is a block diagram illustrating an example of the hardware configuration of the information processing device 1.

As illustrated in the drawing, the information processing device 1 includes a processor unit 11. The processor unit 11 is designed as a signal processing unit including at least a CPU, and functions as an arithmetic processing unit that performs various processes.

The processor unit 11 performs various processes in accordance with a program stored in the ROM 12 or a program loaded from a storage unit 19 into the RAM 13. The RAM 13 also stores, as appropriate, data and the like necessary for the processor unit 11 to execute various kinds of processes.

The processor unit 11, the ROM 12, and the RAM 13 are connected to one another via a bus 14. An input/output interface (I/F) 15 is also connected to the bus 14.

An input unit 16 including an operation element or an operation device is connected to the input/output interface 15. For example, as the input unit 16, various kinds of operation elements and operation devices such as a keyboard, a mouse, keys, a dial, a touch panel, a touch pad, and a remote controller can be considered.

An operation by the user is detected by the input unit 16, and a signal corresponding to the input operation is interpreted by the processor unit 11.

Further, a display unit 17 formed with a liquid crystal display (LCD), an organic electro-luminescence (EL) display, or the like, and an audio output unit 18 formed with a speaker or the like are integrally or separately connected to the input/output interface 15.

The display unit 17 is used for displaying various kinds of information, and is formed with a display device provided in the housing of the information processing device 1, a separate display device connected to the information processing device 1, or the like, for example.

The display unit 17 displays an image for various kinds of image processing, a moving image to be processed, or the like on a display screen, on the basis of an instruction from the processor unit 11. Further, the display unit 17 displays various operation menus, icons, messages, and the like, or performs display as a graphical user interface (GUI), on the basis of an instruction from the processor unit 11.

In some cases, the storage unit 19 formed with a hard disk drive (HDD), a solid-state memory, or the like, and a communication unit 20 formed with a modem or the like are connected to the input/output interface 15.

The communication unit 20 performs communication through a communication process via a transmission line such as the Internet, wired/wireless communication with various devices, bus communication, or the like.

Furthermore, a drive 21 is also connected to the input/output interface 15 as necessary, and a removable recording medium 22, such as a magnetic disk, an optical disk, a magneto-optical disk, or a semiconductor memory, is mounted thereon as appropriate.

A data file such as a program to be used for each process can be read from the removable recording medium 22 by the drive 21. The read data file is stored into the storage unit 19, and an image or sound included in the data file is output by the display unit 17 or the audio output unit 18. Furthermore, a computer program or the like read from the removable recording medium 22 is installed into the storage unit 19 as necessary.

In the information processing device 1 having the hardware configuration as described above, software for the processing according to the present embodiment can be installed via network communication by the communication unit 20 or the removable recording medium 22, for example. Alternatively, the software may be stored into the ROM 12, the storage unit 19, or the like in advance.

As the processor unit 11 performs processing on the basis of various programs, the information processing and the communication processing necessary as the information processing device 1 as described later are performed.

### 1-3. Motion Data Conversion Technique as the First Embodiment

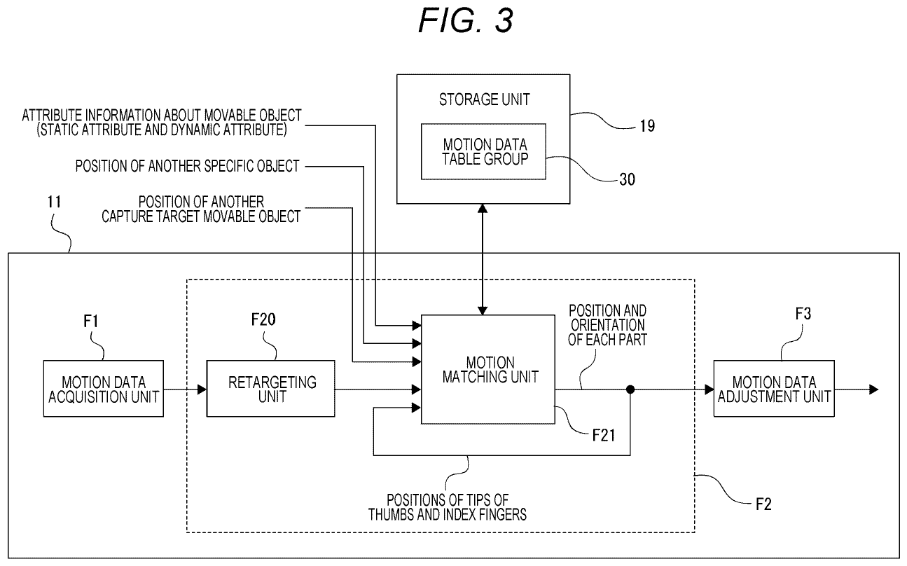

FIG. 3 is an explanatory diagram of an example configuration for implementing a motion data conversion technique as the first embodiment, and illustrates the functional configuration of the processor unit 11 and the storage unit 19 shown in FIG. 2.

In this example, the functions as the motion data acquisition unit F1 and the motion data conversion unit F2 described above are functions to be implemented through a software process performed by the processor unit 11.

Also, the processor unit 11 in this example has functions as a motion data adjustment unit F3.

The motion data conversion unit F2 has functions as a retargeting unit F20, and functions as a motion matching unit F21.

The retargeting unit F20 performs a retargeting process on the motion data obtained by the motion data acquisition unit F1, to convert the position of each part of the motion data so as to have a skeleton data format assumed in a motion matching process by the motion matching unit F21.

Here, it is also conceivable that the retargeting unit F20 performs processing such as adjustment of the body size of the movable object Ob as the capture target for the motion data.

Note that, in a case where the data format of the motion data input from the motion data acquisition unit F1 is close to the data format of the motion data assumed in the motion matching process by the motion matching unit F21, the retargeting unit F20 is unnecessary.

The motion matching unit F21 inputs the captured motion data processed by the retargeting unit F20, and performs a motion data conversion process to obtain motion data including a larger number of pieces of part data than the captured motion data, through a motion matching process based on the captured motion data.

The motion matching unit F21 according to the present embodiment uses not only the captured motion data but also attribute information about the movable object Ob in the motion data conversion process.

Here, the “attribute information” about the movable object Ob broadly means information indicating the attributes of the movable object Ob. The attributes mentioned herein include a static attribute and a dynamic attribute. The static attribute means an attribute that remains unchanged regardless of movement of the movable object Ob. For example, in a case where the movable object Ob is a person related to a sports game as in this example, the static attribute may be a role attribute or the like of the person (in the case of soccer, for example, the attribute depends on categories such as goalkeeper, forward, defender, referee, and the like). Meanwhile, the dynamic attribute means an attribute that can change depending on movement of the movable object Ob, and may be an attribute depending on categories such as running, not moving, walking, and jumping, for example.

For example, if the attribute of the movable object varies as in a case where the target movable object is a player, a case where the target movable object is a referee, a case where the target movable object is running, a case where the target movable object is not moving, and the like, the action to be taken by the movable object may vary. Therefore, the attribute information is used in the motion data conversion as described above, so that the accuracy of the motion data conversion can be increased.

The motion matching unit F21 of this example uses both static attribute information and dynamic attribute information as the attribute information about the movable object Ob.

Further, the motion matching unit F21 according to the present embodiment uses information indicating a positional relationship between the movable object Ob and another object in the motion data conversion process.

Accordingly, if the target scene is a soccer game or the like, for example, the motion data conversion can be performed on the basis of a positional relationship with another object, such as a positional relationship with an object as another player or an object as the ball being used, for example.

Since the action to be taken by the target movable object may vary depending on the positional relationship with another object as in a case where another object is located far away and a case where another object is located nearby, for example, the accuracy of the motion data conversion can be increased with information indicating a positional relationship with another object in the motion data conversion as described above.

The motion matching unit F21 in this example uses information indicating a positional relationship with another capture target movable object and information indicating a positional relationship with another specific object as the information indicating a positional relationship with another object.

“Another capture target movable object” means a movable object that is a motion capture target different from the movable object Ob serving as the motion data conversion target in the motion data conversion process. For example, if the target scene is a soccer game or the like, another capture target movable object is assumed to be another player, a referee, or the like.

Further, “another specific object” mentioned herein means a specific object that is neither the movable object Ob as the motion data conversion target in the motion data conversion process, nor another capture target movable object. For example, if the target scene is a soccer game or the like, the ball (the ball being used), a goal, an obstacle, or the like is an example of another specific object.

In this example, information about the position of another capture target movable object in a three-dimensional space and information about the position of another specific object in the three-dimensional space are used as the information indicating a positional relationship with another capture target movable object and the information indicating a positional relationship with another specific object, respectively. The three-dimensional space mentioned herein means a three-dimensional space assumed in motion capture of the movable object Ob. That is, if the target scene is a sports game such as soccer, the space in which the game is performed is defined by X-, Y-, and Z-coordinates as the three-dimensional space.

Note that, as the information indicating a positional relationship between the movable object Ob and another object, it is also conceivable to use information indicating a difference in position between the movable object Ob and another object (information or the like indicating a distance and a direction, for example), instead of information about the position of another object in such a three-dimensional space.

Further, the motion matching unit F21 in the present embodiment feeds back the position information about the tips of fingers of the movable object Ob obtained in the immediately preceding motion data conversion process, to the input for the motion matching process. Specifically, only the position information about the tips of the thumbs and the tips of the index fingers among the position information about the tips of the fingers of the movable object Ob obtained in the immediately preceding motion data conversion process is fed back to the input for the motion matching process.

By performing motion matching involving the positions of the tips of the fingers in such a manner, it is possible to increase the accuracy of the motion data conversion compared with that in a case where motion matching does not involve the positions of the tips of the fingers. In particular, by feeding back only the position information about the tips of the thumbs and the tips of the index fingers to the input for the motion matching process, it is possible to increase the accuracy of the motion data conversion as compared with that in a case where information about the positions of the tips of all the fingers is fed back.

Here, in the motion data conversion through the motion matching process, motion data tables showing correspondence relationships between input motion data and output motion data (converted motion data) are used.

As described above, in this example, the attribute information about the movable object Ob and the information indicating positional relationships with other objects (other capture target movable objects and other specific objects) are used in the motion data conversion. Therefore, a plurality of tables showing the correspondence relationship between input motion data and output motion data is used as the motion data tables for the respective types among a plurality of situation types specified from combinations of the attribute information and the information indicating the positional relationships with other objects.

In the information processing device 1, the plurality of motion data tables prepared for the respective situation type as described above is stored as a motion data table group 30 in the storage unit 19.

Hereinafter, each motion data table (which is each of the motion data tables prepared for the respective situation types) included in the motion data table group 30 will be referred to as a “motion data table 30a”.

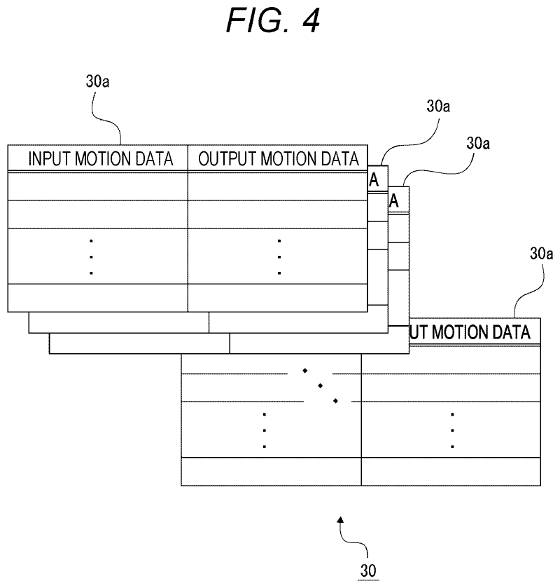

FIG. 4 illustrates a concept image of the motion data table group 30.

Here, examples of categories of situation types include a category in which the movable object Ob is a player as a defender (static attribute information) and is in a running state (dynamic attribute information), and another capture target movable object is located far away (positional relationship with another capture target movable object) while another specific object is located nearby (positional relationship with another specific object), a category in which the movable object Ob is a player as a goalkeeper (static attribute information) and is in an unmoving state (dynamic attribute information), and another capture target movable object is located nearby (positional relationship with another capture target movable object) while another specific object is located nearby (positional relationship with another specific object), and the like.

In the motion data table group 30, each motion data table 30a is generated beforehand so as to indicate the correspondence relationship between input motion data and output motion data for each situation type specified from the combinations of the attribute information about the movable object Ob and the information indicating the positional relationship with other objects (another capture target movable object and another specific object).

In this example, the captured motion data is motion data about 14 parts including parts such as the chest, both knees, both legs, both shoulders, both elbows, and both hands in the movable object Ob as a person (not including information about each joint and the tips of the fingers of both hands as described above). Further, in the present example as described above, the data of the tip portions of the thumbs (both thumbs) and the index fingers (both index fingers) output immediately before that is fed back to the input for the motion matching process. Therefore, the motion data of the respective parts of a total of 18 parts including the tip portions of the thumbs and the index fingers to be fed back is stored as the input motion data in the respective motion data tables 30a.

On the other hand, as the output motion data in this example, the motion data of a total of 42 respective parts including the above-described 14 parts, and predetermined joints and the tips of the respective fingers of both hands is stored.

In the motion data tables 30a, it is conceivable to capture and acquire motion of the movable object Ob as the output motion data for each possible situation type, using a high-precision motion capture system such as an OptiTrack, for example.

As for the input motion data, on the other hand, it is conceivable to use data obtained by extracting data of each of the above-described 18 parts from the output motion data acquired with a high-precision motion capture system as described above, for example. Alternatively, it is also conceivable to use, as the input motion data, motion data acquired by capturing motion of the movable object Ob with a low-precision motion capture system by a kinect method or the like at the same time as a high-precision motion capture system.

In FIG. 3, the motion matching unit F21 performs a motion data conversion process by motion matching with reference to the corresponding motion data table 30a in the motion data table group 30, on the basis of the captured motion data (14 parts) processed by the retargeting unit F20, the motion data of a total of 18 parts including the positions of the tips of the thumbs and the index fingers to be fed back as an input, the static attribute information and the dynamic attribute information about the movable object Ob, the position information about another capture target movable object, and the position information about another specific object.

Specifically, the motion matching unit F21 identifies the situation type of the movable object Ob, on the basis of the static attribute information and the dynamic attribute information about the movable object Ob, the position information about another capture target movable object, and the position information about another specific object. The motion data table 30a corresponding to the identified situation type is then selected from among the motion data tables 30a in the motion data table group 30, and the output motion data corresponding to the conversion target motion data (the motion data of the 18 parts in this example) is identified on the basis of the selected motion data table 30a.

In this example, the corresponding output motion data is identified by the technique of first searching for the input motion data most similar to the conversion target motion data among the input motion data in the motion data table 30a, and identifying the output motion data associated with the retrieved input motion data.

Specifically, when the respective parts in the conversion target motion data are defined as PI₀ to PI₁₇, and the respective parts in the J-th (J being an integer of 0 or greater) input motion data in the motion data table 30a are defined as PDJ₀ to PDJ₁₇, the total value of the absolute values of the differences between the positions of these parts is calculated according to [Expression 1] shown below.

$$\begin{matrix}[ Math . 1 ] & \\ {\sum }_{i = 1}^{17} \vert {PI}_{i} - {PDJ}_{i} \vert & [ Expression 1 ]\end{matrix}$$

The output motion data associated with the input motion data having the minimum total value is then output as the motion data after conversion (converted motion data) for the conversion target motion data.

Thus, a conversion process from low-quality motion data (14 parts in this example) to high-quality motion data (42 parts in this example) is performed.

Here, it is conceivable to use information designated by a user operation as the attribute information about the movable object Ob to be input to the motion matching unit F21 and the information indicating positional relationships with other objects. Alternatively, as at least one piece of the attribute information about the movable object Ob and the information indicating positional relationships with other objects, it is conceivable to use information obtained on the basis of the captured motion data, or, in a case where the sensor device 2 includes an image sensor, it is conceivable to use information obtained from an image analysis process performed on an image captured by the image sensor.

In this example, the converted motion data obtained by the motion data conversion unit F2 (the motion matching unit F21) is processed by the motion data adjustment unit F3.

The motion data adjustment unit F3 adjusts the motion data newly obtained through the motion data conversion process by the motion data conversion unit F2, on the basis of the motion data output immediately before that. Specifically, the motion data adjustment unit F3 adjusts the motion data of the fingers of the movable object Ob newly obtained through the motion data conversion process, on the basis of the motion data of the fingers output immediately before that and the velocity of the hands of the movable object Ob.

More specifically, the motion data adjustment unit F3 performs a process of blending the positions and orientations of the respective parts of the respective fingers newly obtained through the motion data conversion process and the positions and orientations of the respective parts of the respective fingers output immediately before that, at a blend ratio corresponding to the velocity of the hands.

By performing the motion data adjustment process as described above, it is possible to reduce the feeling of strangeness caused by a sudden change in motion between frames. In particular, by performing an adjustment process based on the velocity of the hands as described above, it becomes possible to change the degree of adjustment for the motion data of the fingers based on the immediately preceding output in accordance with the velocity of the hands. Specifically, in a case where the velocity of the hands is high, for example, it is possible to increase the degree of reflection of the newly obtained motion data. In a case where the velocity of the hands is low, it is possible to increase the degree of reflection of the motion data output immediately before that. Thus, the feeling of strangeness about the motion data can be further reduced.

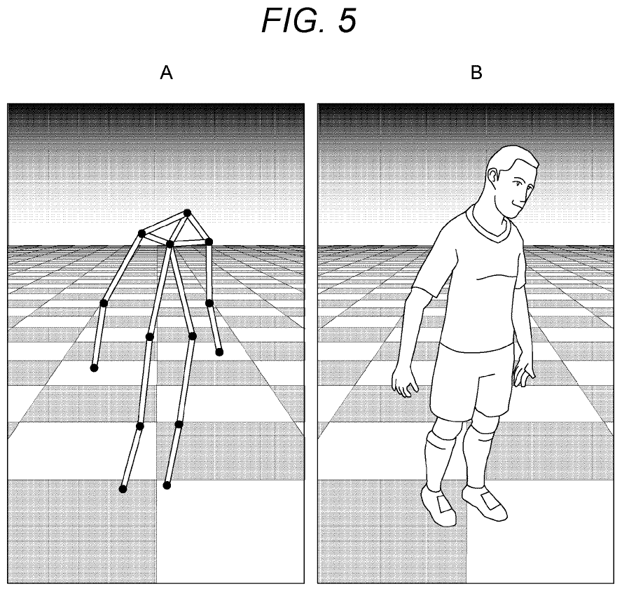

The effects of the motion data conversion process as the first embodiment as described above are now described with reference to FIGS. 5 to 8.

In FIGS. 5 to 8, each drawing A illustrates an example of the motion data (skeleton data: data of each of the 14 parts) to be input to the motion data conversion unit F2, and each drawing B illustrates a result of generation of a three-dimensional model of the movable object Ob based on the converted motion data (the data adjusted by the motion data adjustment unit F3) obtained from the input illustrated in the drawing A.

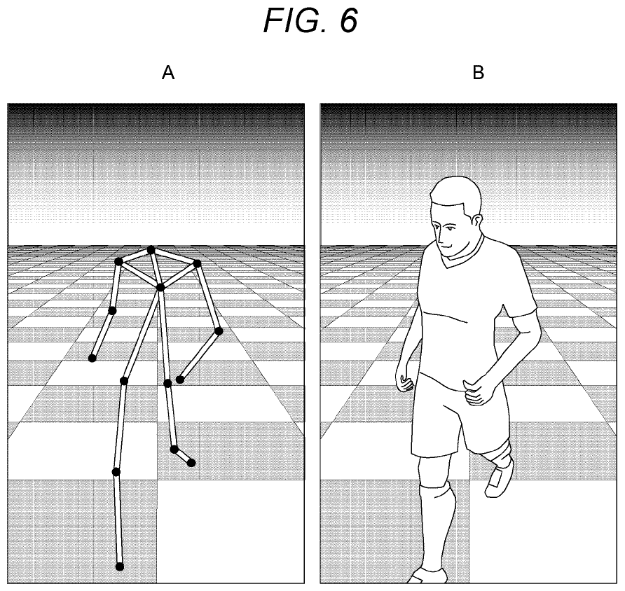

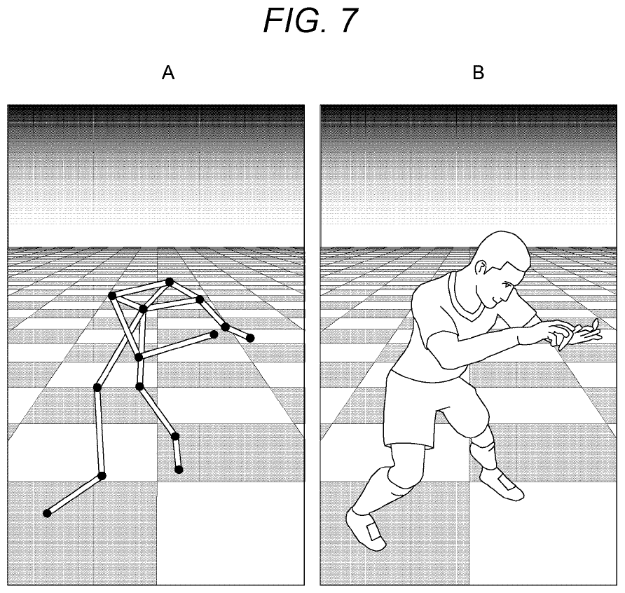

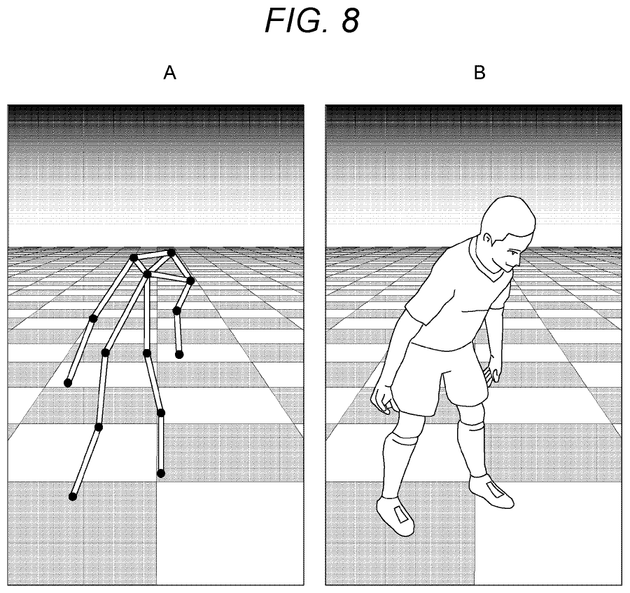

FIGS. 5 to 8 illustrate the results in a case where the movable object Ob as the capture target is a goalkeeper. FIG. 5 illustrates the posture of the goalkeeper at a time when the other players and the ball are located far away, with the attribute being a static attribute “not moving”. FIG. 6 illustrates the posture of the goalkeeper at a time when the other layers and the ball are located far away, with the attribute being a static attribute “running”. FIG. 7 illustrates the posture of the goalkeeper at a time when the opposing team players and the ball are located very close to the goalkeeper, with the attribute being a static attribute “not moving”. FIG. 8 illustrates the posture of the goalkeeper at a time when the opposing team players holding the ball are located relatively close to the goalkeeper, with the attribute being a static attribute “not moving”.

In the case illustrated in FIG. 5, it can be seen from the converted motion data that the fingers are pointing downward and are in an opened state. In the situation in FIG. 5, the other players and the ball are located very far, and therefore, the tension of the goalkeeper is relatively low. Accordingly, it can be said that reproduction of such fingers matches the situation and is appropriate.

Further, in the case illustrated FIG. 6, the converted motion data shows clenched hands. It can be said that this is appropriate as representation of fingers while the target is running.

The situation in FIG. 7 is a situation where the opposing team players and the ball are very close to the target, and there is a high possibility that a shoot will be made. In this situation, the converted motion data shows that both hands are open forward to catch a flying ball. Accordingly, in this case, it can also be said that the fingers shown herein appropriately match the situation.

In FIG. 8, it can be seen that the goalkeeper is in a posture in response to the opposing team player holding the ball being at a slightly close position. Accordingly, it can be said that a posture appropriately matching the situation is represented. Further, even when attention is paid to the fingers, it can be seen that natural representation is realized as shape representation.

### 1-4. Processing Procedures

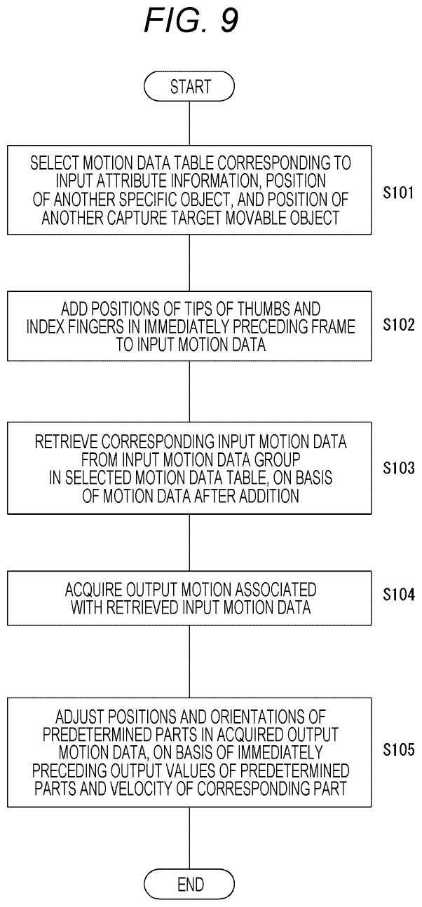

Referring now to a flowchart in FIG. 9, an example of the processing procedures for implementing the motion data conversion technique as the first embodiment described above is explained.

In this example, the process illustrated in FIG. 9 is performed by the processor unit 11 in the information processing device 1, according to a program stored in a predetermined storage device such as the ROM 12, for example.

Further, in this example, it is assumed that motion capture by the sensor device 2 and the motion data acquisition unit F1 is repeatedly performed in predetermined frame cycles, and a motion data conversion process is performed for each frame. Therefore, the processor unit 11 repeatedly performs the process illustrated in FIG. 9 for the respective frames.

First, in step S101, the processor unit 11 selects the motion data table 30a corresponding to the input attribute information, the position of another specific object, and the position of another capture target movable object. Specifically, the situation type of the movable object Ob is identified on the basis of the input static attribute information and dynamic attribute information about the movable object Ob, the position information about another capture target movable object, and the position information about another specific object, and the motion data table 30a corresponding to the specified situation type is selected from among the motion data tables 30a in the motion data table group 30.

In step S102 subsequent to step S101, the processor unit 11 performs a process of adding the positions of the tips of the thumbs and the index fingers in the immediately preceding frame to the input motion data. That is, a process of adding the data of the positions of the tips of the thumbs and the index fingers in the converted motion data obtained through a motion data conversion process (the process in step S104 described later) performed on the immediately preceding frame is performed on the motion data (14 parts) that has been input from the retargeting unit F20.

Note that, in a case where the target frame is the first frame, it is conceivable to add predetermined positions, such as positions estimated from captured motion data or the like by a predetermined method or positions separated at predetermined distances in a predetermined direction from the positions of the hands in the captured motion data, as the positions of the tips of the thumbs and the index fingers.

In step S103 subsequent to step S102, the processor unit 11 searches for the corresponding input motion data from the input motion data group in the selected motion data table 30a, on the basis of the motion data after the addition. Specifically, for each piece of the input motion data in the selected motion data table 30a, the total value expressed by [Expression 1] shown above is calculated, and the input motion data having the minimum total value is identified.

In step S104 subsequent to step S103, the processor unit 11 acquires the output motion data associated with the retrieved input motion data. That is, the output motion data associated with the input motion data identified as having the minimum total value is acquired.

In step S105 subsequent to step S104, the processor unit 11 performs a process of adjusting the positions and orientations of predetermined parts in the acquired output motion data, on the basis of the immediately preceding output values of the predetermined parts and the velocity of the corresponding part. This corresponds to the process to be performed by the motion data adjustment unit F3 described above. Specifically, the processor unit 11 performs a process of blending the positions and orientations of the respective parts of the respective fingers in the output motion data acquired in step S104 and the positions and orientations of the respective parts of the respective fingers that have been output immediately before that (or in the motion data after the adjustment process performed in step S105 on the immediately preceding frame) at a blend ratio corresponding to the velocity of the hands.

Note that the velocity of the hands can be calculated from information about the positions of the hands acquired at least in the current frame and the immediately preceding frame.

After the execution of the process in step S105, the processor unit 11 ends the series of processes illustrated in FIG. 9 (which is the processing of one frame).

### 2. Second Embodiment

Next, a second embodiment is described.

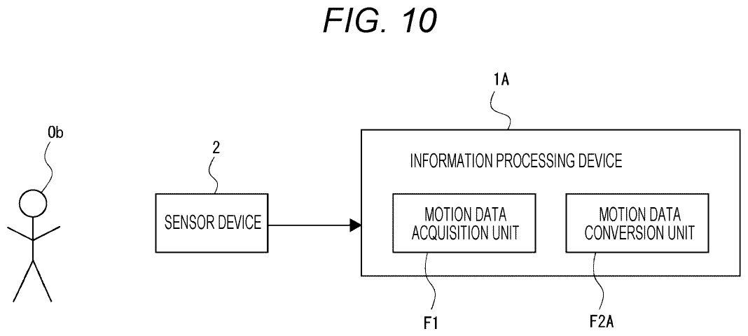

FIG. 10 is a block diagram illustrating an example configuration of a motion data conversion system as a second embodiment.

Note that, in the description below, portions similar to the portions already described are denoted by the same reference signs as above, and explanation thereof is not made herein.

A difference from the case of the first embodiment illustrated in FIG. 1 is that an information processing device 1A is included in place of the information processing device 1. The information processing device 1A differs from the information processing device 1 in including a motion data conversion unit F2A in place of the motion data conversion unit F2.

The motion data conversion unit F2A performs a motion data conversion process through an inference process using an artificial intelligence model that regards captured motion data as input data.

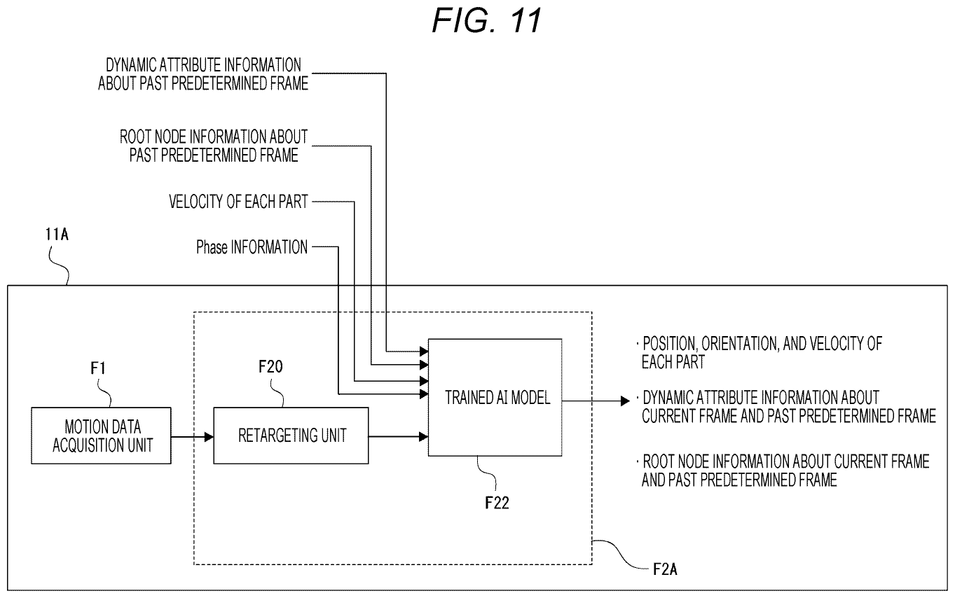

FIG. 11 is an explanatory diagram of functions of the information processing device 1A as the second embodiment.

Here, the hardware configuration of the information processing device 1A is similar to that illustrated in FIG. 2. In the description below, however, the processor unit 11 included in the information processing device 1A will be referred to as the processor unit 11A.

The functions of the motion data acquisition unit F1 and the motion data conversion unit F2A included in the information processing device 1A are implemented through software processing by the processor unit 11A in this example.

The motion data conversion unit F2A includes a trained artificial intelligence (AI) model F22, as well as the retargeting unit F20 described in the first embodiment. The trained AI model F22 is an AI model that has been trained so as to be able to infer motion data having a larger number of pieces of part data than captured motion data as the output data, using the captured motion data as the input data.

Specifically, the trained AI model F22 in this example has been trained so as to be able to obtain the output data that is the motion data (the positions and orientations of the respective parts) having the larger number of pieces of part data and the velocities (the velocities of the respective parts), the dynamic attribute information about the current frame and a past predetermined frame, and root node information about the current frame and the past predetermined frame, using the input data that is the dynamic attribute information about the past predetermined frame of the target movable object Ob, root node information about the past predetermined frame, the velocities of the respective parts (the velocities of the respective parts in the captured motion data), and phase information, together with the captured motion data processed by the retargeting unit F20.

Here, in this example, it is assumed that the motion data is handled in the form of a tree structure, and the above-described root node information means information about the positions and orientations of the parts as the root nodes in a case where the motion data is handled in the form of a tree structure as described above. The root node information about the above-described past predetermined frame can be used as information indicating a movement locus of the movable object Ob.

Further, the phase information is information indicating an operation cycle for the predetermined parts of the movable object Ob. For example, it is conceivable to use information about a walking cycle estimated from motion of the feet, information about a swing cycle of the hands estimated from motion of the hands, or the like.

As for the dynamic attribute information to be input to the trained AI model F22, it is conceivable to use information designated by a user operation, for example. Alternatively, it is conceivable to use information obtained on the basis of captured motion data, or, in a case where the sensor device 2 includes an image sensor, it is also conceivable to use information obtained from an image analysis process performed on an image captured by the image sensor.

Further, the velocity of each part is calculated on the basis of the captured motion data of the current frame and the captured motion data of the immediately preceding frame.

Furthermore, as for the root node information, information about the positions and orientations of the corresponding parts in the captured motion data is used.

Further, as for the phase information, it is conceivable to use information estimated from motion of predetermined parts such as the feet or the hands in the captured motion data, for example.

Note that, to increase the efficiency of arithmetic processing (in particular, a convolution arithmetic process and the like) in the trained AI model F22, a processor unit in which processors different from a CPU, such as a graphics processing unit (GPU) and a digital signal processor (DSP), are combined can also be used as the processor unit 11A.

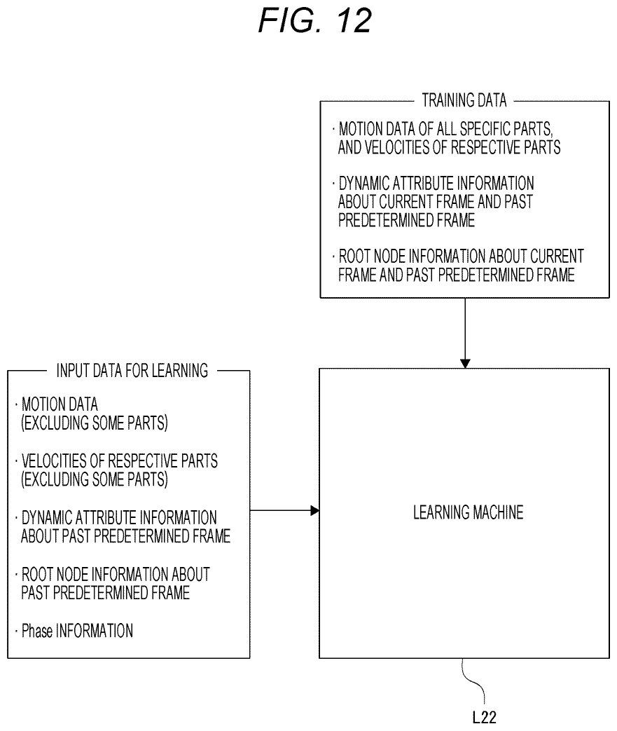

FIG. 12 is an explanatory diagram of machine learning for obtaining the trained AI model F22.

In the machine learning in this case, the motion data of all the specific parts, the velocities of the respective parts, the dynamic attribute information about the current frame and the past predetermined frame, and the root node information about the current frame and the past predetermined frame are used as the training data. As the motion data of all the specific parts herein, motion data obtained by capturing motion of the movable object Ob with a high-precision motion capture system such as an OptiTrack is used, for example.

Further, as the input data for learning, motion data excluding some parts, or, in particular, motion data excluding the respective pars (the joints and tips) in the respective fingers of both hands, the velocities of the respective parts excluding some parts, which is the velocities of the respective parts excluding the respective parts in the respective fingers of both hands, dynamic attribute information about a past predetermined frame, root node information about the past predetermined frame, and phase information are used.

As the motion data to be used as the input data for learning, motion data obtained by removing (decimating) the respective parts in the respective fingers of both hands from the motion data of all the specific parts to be used as the training data is used, for example. Further, as the velocity information to be used as the input data for learning, information about the velocities of the respective parts in such decimated motion data is used.

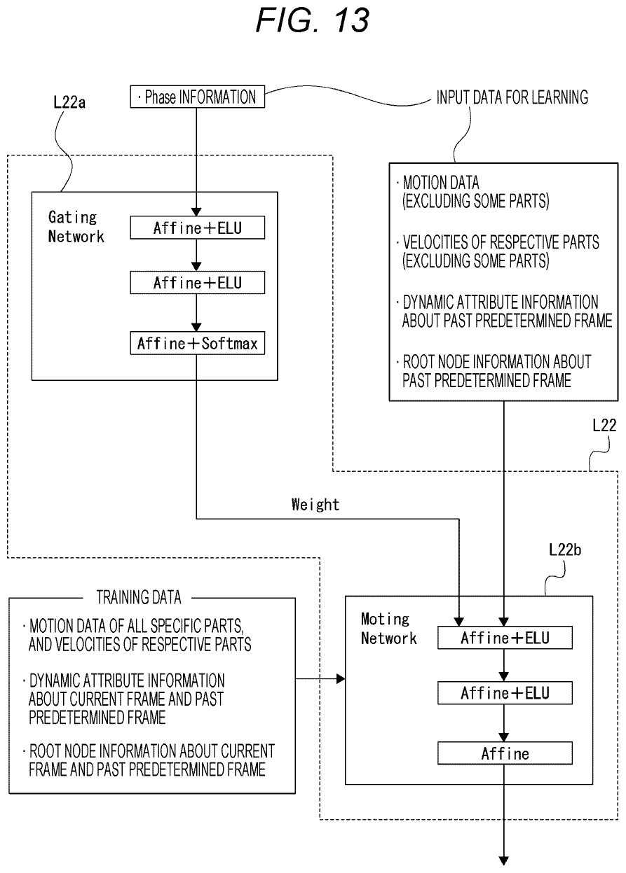

FIG. 13 is a diagram illustrating an example configuration of a learning machine L22.

As illustrated in the drawing, as the learning machine L22, one including a gating network L22a and a motion network L22b is used. The gating network L22a is a network that estimates the weight to be used in a convolution arithmetic process by the motion network L22b, using phase information as the input data, and is useful for estimating motion of the legs or the like. The motion network L22b is a network that outputs motion data of all the specific parts, the velocities of the respective parts, dynamic attribute information about the current frame and a past predetermined frame, and root node information about the current frame and the past predetermined frame, using the input data that is the motion data excluding some parts, the velocities of the respective parts excluding some parts, the dynamic attribute information about the past predetermined frame, and the root node information about the past predetermined frame illustrated as the input data for learning in FIG. 12.

The machine learning in this case is performed in a mode in which, among the data shown as the input data for learning in FIG. 12, the phase information is the input data for the gating network L22a, the motion data excluding some parts, the velocities of the respective parts excluding some parts, the dynamic attribute information about the past predetermined frame, and the root node information about the past predetermined frame are the input data for the motion network L22b, and, further, the motion data of all the specific parts, the velocities of the respective parts, the dynamic attribute information about the current frame and the past predetermined frame, and the root node information about the current frame and the past predetermined frame, which are shown as the training data in FIG. 12, are given as the training data to the motion network L22b.

Note that the configuration of the learning machine L22 is not limited to that illustrated in FIG. 13, and a recurrent neural network (RNN) such as a long short term memory (LSTM) may be used, for example.

Note that, in the example described above, a conversion process using the dynamic attribute information about the movable object Ob is performed as a motion data conversion process using an artificial intelligence model. However, a motion data conversion process based on static attribute information can also be performed through machine learning using the static attribute information about the movable object Ob.

Also, in the second embodiment, by performing machine learning using information indicating positional relationships with another capture target movable object and another specific object, it is also possible to perform a conversion process based on information indicating positional relationships with another capture target movable object and another specific object as a motion data conversion process using an artificial intelligence model.

Further, the second embodiment can also adopt a component that performs processing as the motion data adjustment unit F3. That is, processing as the motion data adjustment unit F3 described above can be performed on motion data inferred by the trained AI model F22.

### 3. Third Embodiment

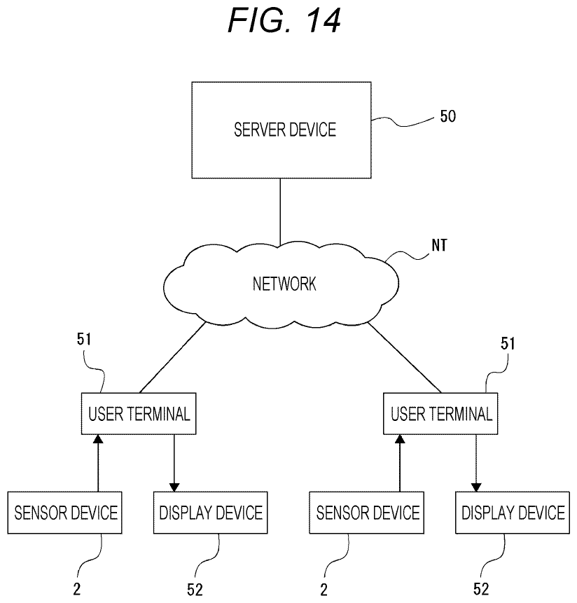

FIG. 14 is a block diagram illustrating an example configuration of a motion data conversion system as a third embodiment.

In the third embodiment, the motion data conversion process described in the first and second embodiments is applied in a case where an avatar (a three-dimensional model) of each user is moved on the basis of a motion capture result in a virtual space such as a metaverse shared among a plurality of users. In this case, it is assumed that each user performs motion capture at home or the like, and it would be difficult to use a high-precision motion capture system such as an OptiTrack. Therefore, it is preferable to adopt the motion data conversion process described in the first and second embodiments.

As illustrated in the drawing, the motion data conversion system as the third embodiment includes a server device 50, a plurality of user terminals 51, and sensor devices 2 and display devices 52 provided for the respective user terminals 51. Here, for ease of explanation, it is assumed that there are two user terminals 51. Hereinafter, the user of one user terminal 51 will be referred to as the first user, and the user of the other user terminal 51 will be referred to as the second user.

A user terminal 51 is designed as a computer device including a CPU, a ROM, a RAM, and the like, for example. Examples of the device form of the user terminals 51 include device forms such as personal computers, smartphones, and tablet terminals. Note that a user terminal 51 may have a configuration in which the user terminal 51 is integrated with at least one of a sensor device 2 and a display device 52. A display device 52 is formed as a display device capable of displaying an image, such as an LCD or an organic EL display, for example.

The server device 50 is formed as a computer device including a CPU, a ROM, a RAM, and the like, for example, and is designed to be capable of performing data communication with each user terminal 51 via a network NT formed with the Internet or the like, for example.

In this example, the hardware configuration of the server device 50 is similar to that illustrated in FIG. 2 described above, and therefore, explanation thereof is not repeated herein.

The server device 50 generates virtual space information for reproducing a virtual space including an avatar of each user on the basis of motion data (captured motion data) obtained by the user terminals 51 performing motion capture on the users, and provides the generated virtual space information to the respective user terminals 51.

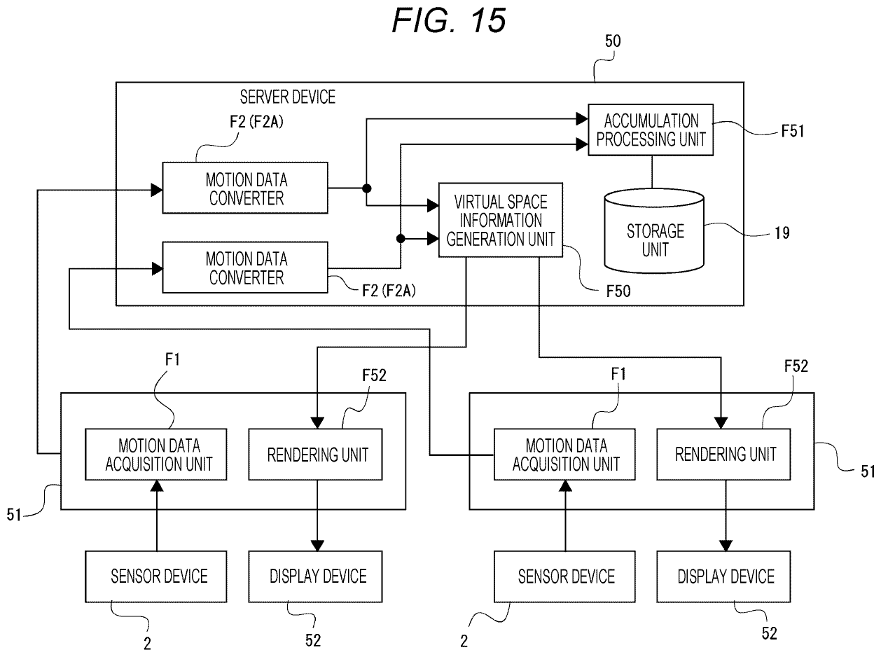

FIG. 15 is an explanatory diagram of the functions of the server device 50 and each user terminal 51.

As illustrated in the drawing, each user terminal 51 includes a motion data acquisition unit F1 and a rendering unit F52.

Meanwhile, the server device 50 includes a motion data conversion unit F2, a virtual space information generation unit F50, and an accumulation processing unit F51. As illustrated in the drawing, the motion data conversion unit F2 is provided for each user terminal 51. Here, the motion data conversion unit F2 described in the first embodiment is used as an example, but the motion data conversion unit F2A described in the second embodiment can also be used.

Note that the accumulation processing unit F51 will be described later.

The motion data acquisition unit F1 in one user terminal 51 performs motion capture on the movable object Ob as the first user to acquire motion data and inputs the motion data to one motion data conversion unit F2, which then performs a motion data conversion process, to obtain motion data having a larger number of pieces of part data (this motion data will be hereinafter referred to as the “converted motion data”).

Also, the motion data acquisition unit F1 in the other user terminal 51 performs motion capture on the movable object Ob as the second user to acquire motion data and inputs the motion data to the other motion data conversion unit F2, which then performs a motion data conversion process, to obtain the converted motion data.

On the basis of the converted motion data of the first user and the converted motion data of the second user input from the respective motion data conversion units F2, the virtual space information generation unit F50 generates avatars as three-dimensional models of the first and second users, which are three-dimensional models reflecting motion of the respective users, generates virtual space information for reproducing a virtual space including those avatars, and transmits the generated virtual space information to the respective user terminals 51.

In each user terminal 51, the rendering unit F52 renders the virtual space information received from the server device 50 to generate an image representing the virtual space including the avatar, and causes the display device 52 to display the image.

Note that the rendering unit F52 may be provided with a function for a reprojection process to shorten a delay to be perceived.

With the above configuration, it is possible to present, to each user, an image in which the avatar of each user reflecting movement of the user is disposed in a common virtual space such as a metaverse.

At this point of time, a motion data conversion process is performed in the server device 50, and thus, a low-precision (low-cost) motion capture system can be used as the motion capture system prepared on the user side.

Note that, in the third embodiment, each set of the captured motion data obtained by the respective user terminals 51 is data in a device coordinate system. Therefore, to share the posture in the virtual space, it is necessary to convert the captured motion data into data in a common virtual space coordinate system in practice. This coordinate conversion process may be performed on the side of the user terminals 51, or may be performed on the side of the server device 50.

Also, in the above example, the motion data conversion unit F2 is provided for each user terminal 51, and the motion data conversion processes for the respective users are performed in parallel. However, it is also conceivable to make the number of the motion data conversion units F2 smaller than the number of the users, and perform the motion data conversion processes for the respective users in a time-division manner.

Here, in the server device 50, the accumulation processing unit F51 performs a process of causing a storage device to store the converted motion data of the respective users obtained by the motion data conversion unit F2. Specifically, a process of storing data into the storage unit 19 included in the server device 50 is performed.

In this case, the converted motion data of the respective users can be rephrased as high-quality motion data obtained for a plurality of movable objects Ob having an interactive relation in the virtual space.

Accordingly, the converted motion data of the respective users accumulated by the accumulation processing unit F51 as described above is preferably used for machine learning of a motion data inference model taking into consideration interactions between the movable objects Ob. Specifically, in a case where high-quality motion data is used as the training data in machine learning of a motion data inference model taking into consideration interactions between the movable objects Ob, the use of the high-quality motion data is preferable in that there is no need to use a high-precision motion capture system.

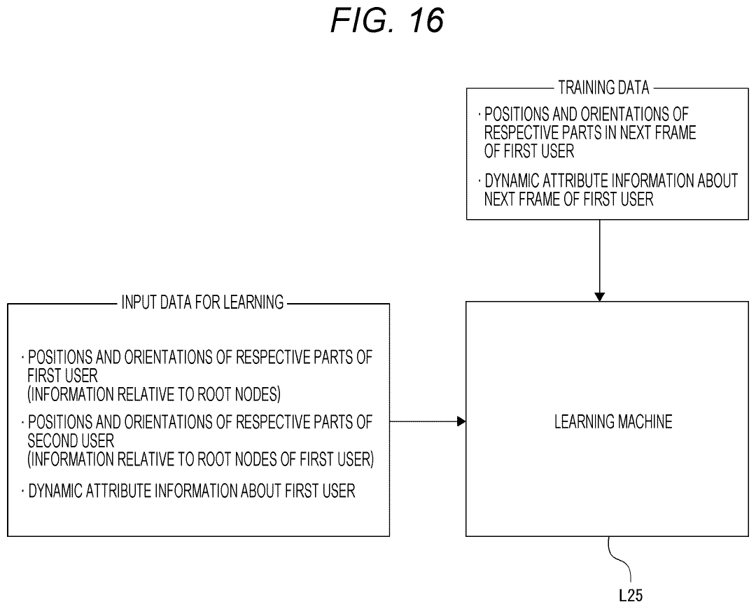

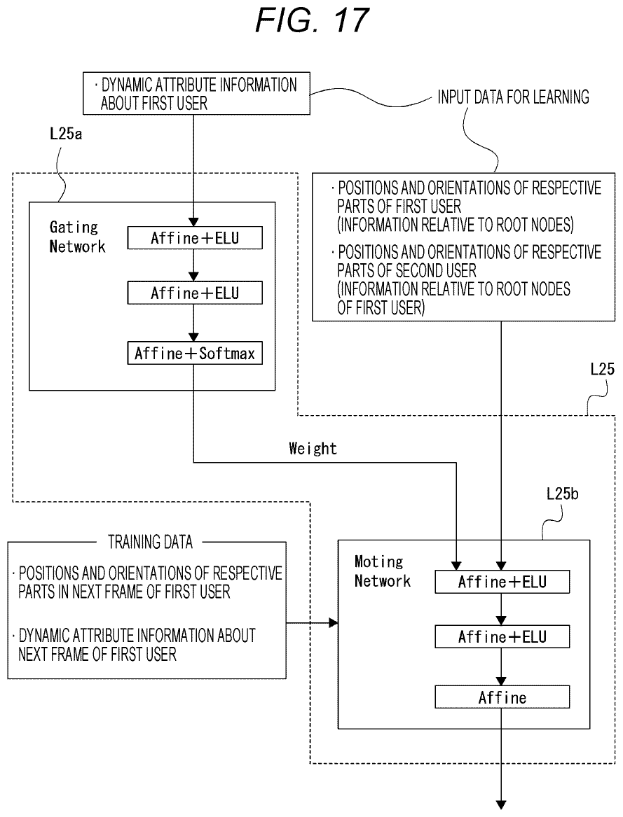

Referring now to FIGS. 16 and 17, an example of machine learning of a motion data inference model taking interactions between users into consideration, which is performed with the accumulated converted motion data of the respective users, is described.

As a premise, the inference herein is performed in a format of predicting motion data of at least the next frame of the first user on the basis of input data including motion data of the first user and the second user in a certain frame.

A learning machine to be used to perform such inference is referred to as a learning machine L25.

As illustrated in the drawing, the positions and orientations of the respective parts of the first user, the positions and orientations of the respective parts of the second user, and dynamic attribute information about the first user are used as the input data for learning.

In this case, information about the relative positions and relative orientations with respect to the root nodes in the motion data of the first user is used as the positions and orientations of the respective parts of the first user. Also, information about the relative positions and relative orientations of the first user with respect to the root nodes is used as the positions and orientations of the respective parts of the second user.

As the training data, the positions and orientations of the respective parts in the next frame of the first user, and the dynamic attribute information about the next frame of the first user are used.

FIG. 17 is a diagram illustrating an example configuration of the learning machine L25.

As the learning machine L25 in this example, one having two networks similar to those illustrated in FIG. 13 is used. Specifically, as the learning machine L25, one including a gating network L25a and a motion network L25b is used.

The gating network L25a is a network that estimates the weight to be used in a convolution arithmetic process by the motion network L25b using the dynamic attribute information about the first user as the input data. The motion network L25b is a network that outputs the positions and orientations of the respective parts in the next frame of the first user and the dynamic attribute information about the next frame of the first user, using the positions and orientations of the respective parts of the first user and the positions and orientations of the respective parts of the second user shown as the input data for learning in FIG. 16 as the input data.

The machine learning in this case is performed in a mode in which the dynamic attribute information about the first user among the data shown as the input data for learning in FIG. 16 is used as the input data for the gating network L25a, the positions and orientations of the respective parts of the first user and the positions and orientations of the respective parts of the second user are used as the input data for the motion network L25b, and further, the positions and orientations of the respective parts in the next frame of the first user and the dynamic attribute information about the next frame of the first user illustrated as the training data in FIG. 16 are given as the training data to the motion network L25b.

By performing machine learning as described above, it is possible to generate a motion data inference model taking interactions between users into consideration.

Note that the configuration of the learning machine L25 is not limited to that illustrated in FIG. 17, and an RNN may be used, for example.

Here, in the example described above, the converted motion data obtained by performing a motion data conversion process on a plurality of movable objects Ob having interactive relations in a virtual space is accumulated. However, the space is not necessarily a virtual space, and it is also conceivable to accumulate the converted motion data obtained by performing a motion data conversion process on a plurality of movable objects Ob having interactive relations in a real space.

### 4. Modifications

Although embodiments according to the present technology have been described above, the present technology is not limited to the above-described specific examples, and can adopt configurations as various modifications.

For example, in the above description, a motion capture system by a kinect method has been explained as an example of the motion capture system for obtaining motion data (captured motion data) to be converted. However, a system by some other method can also be used as the motion capture system. For example, it is also conceivable to use “Open Pose”, “AR Kit”, or the like as a system that uses images captured by a camera. Also, it is conceivable to use Electronic Performance and Tracking Systems (EPTS) or “Body Tracking” using a “VR Tracker”. Further, it is conceivable to use an inertial motion capture system using an inertial measurement unit (IMU).

### 5. Summary of the Embodiments

As described above, an information processing device (1, 1A, or the server device 50) as an embodiment includes a motion data conversion unit (F2, F2A) that receives an input of captured motion data, which is motion data of a movable object acquired with a motion capture system, and performs a motion data conversion process to obtain motion data having a larger number of pieces of part data than the captured motion data, through a motion matching process based on the captured motion data or an inference process that uses an artificial intelligence model and uses the captured motion data as the input data.

As described above, by performing a process of conversion into motion data having a large number of pieces of part data through a motion matching process or an inference process using an artificial intelligence model, it is possible to obtain the motion data on the peripheral side from the motion data on the center side of the object.

Accordingly, in obtaining high-quality motion data including part information on the peripheral side such as joint information about the fingers of the hands, it is possible to eliminate the need to use a high-precision motion capture system capable of capturing the parts on the peripheral side, and acquire high-quality motion data at low cost.

Also, in the information processing device as an embodiment, a motion data conversion unit uses attribute information about the movable object in the motion data conversion process.

With the above configuration, a conversion process that takes into consideration the attribute information about the target movable object is performed as the motion data conversion process. For example, in a case where the motion matching process is performed, the motion matching process can be performed on the basis of a table of an attribute matching the input attribute among conversion tables prepared for the respective attributes of the movable object. In a case where the inference process is performed, the attribute information about the movable object can be used as one piece of the input information for the inference.

For example, if the attribute of the movable object varies as in a case where the target movable object is a player, a case where the target movable object is a referee, a case where the target movable object is running, a case where the target movable object is not moving, and the like, the action to be taken by the movable object may vary. Therefore, the attribute information is used in the motion data conversion as described above, so that the accuracy of the motion data conversion can be increased.

Further, in the information processing device as an embodiment, the motion data conversion unit uses static attribute information and dynamic attribute information as the attribute information.

Accordingly, as the motion data conversion process, a conversion process based on both static attribute information indicating the role attribute or the like of the movable object and dynamic attribute information indicating the dynamic attribute of the movable object such as the movable object running or not moving is performed.

Thus, the accuracy of the motion data conversion can be increased.

Furthermore, in the information processing device as an embodiment, the motion data conversion unit also uses information indicating a positional relationship between the movable object and another object in the motion data conversion process.

Accordingly, if the target scene is a soccer game or the like, for example, the motion data conversion can be performed on the basis of a positional relationship with another object, such as a positional relationship with an object as another player or an object as the ball being used, for example.

Since the action to be taken by the target movable object may vary depending on the positional relationship with another object as in a case where another object is located far away and a case where another object is located nearby, for example, the accuracy of the motion data conversion can be increased with information indicating a positional relationship with another object in the motion data conversion as described above.

Also, in the information processing device as an embodiment, the motion data conversion unit uses information indicating a positional relationship between the movable object and another capture target movable object in the motion data conversion process.

Another capture target movable object means a movable object that is to be subjected to motion capture, and is different from the movable object to be subjected to motion data conversion in the motion data conversion process.

Accordingly, with the above configuration, the motion data conversion can be performed on the basis of the positional relationship with other players, for example, and the accuracy of the motion data conversion can be increased.

Further, in the information processing device as an embodiment, the motion data conversion unit uses information indicating a positional relationship between the movable object and another specific object in the motion data conversion process.

Another specific object herein means a specific object that is neither the movable object as the motion data conversion target in the motion data conversion process, nor any other capture target movable object. For example, if the target scene is a soccer game or the like, the ball being used, a goal, or the like corresponds to an example of another specific object.

Accordingly, with the above configuration, the motion data conversion can be performed on the basis of the positional relationship with the ball being used or a goal, for example, and the accuracy of the motion data conversion can be increased.

Furthermore, the information processing device as an embodiment includes a motion data adjustment unit (F3) that adjusts motion data newly obtained through the motion data conversion process, on the basis of the immediately preceding output motion data.

With this arrangement, it is possible to reduce the feeling of strangeness to be caused by a rapid change in motion between frames.

Also, in the information processing device as an embodiment, the motion data adjustment unit adjusts the motion data of the fingers of the movable object newly obtained through the motion data conversion process, on the basis of the immediately preceding output motion data of the fingers and the velocity of the hands of the movable object.

As a result, the degree of adjustment for the finger motion data based on the immediately preceding output can be changed in accordance with the velocity of the hands. Specifically, in a case where the velocity of the hands is high, for example, it is possible to increase the degree of reflection of the newly obtained motion data. Conversely, in a case where the velocity of the hands is low, it is possible to increase the degree of reflection of immediately preceding output motion data.

Thus, the feeling of strangeness about the motion data can be further reduced.

Further, in the information processing device as an embodiment, the motion data conversion unit (F2) performs the motion data conversion process through the motion matching process, and feeds back position information about the tips of the fingers of the movable object obtained in the immediately preceding motion data conversion process, to the input for the motion matching process.

By performing motion matching involving the positions of the tips of the fingers as described above, it is possible to increase the accuracy of the motion data conversion, compared with that in a case where motion matching not involving the positions of the tips of the fingers is performed.

Furthermore, in the information processing device as an embodiment, the motion data conversion unit feeds back, to the input for the motion matching process, only the position information about the tips of the thumbs and the tips of the index fingers among the position information of the tips of the fingers of the movable object obtained in the immediately preceding motion data conversion process.

Thus, it is possible to make the accuracy of the motion data conversion higher than that in a case where information about the positions of the tips of all the fingers is fed back.

Also, the information processing device (the server device 50) as an embodiment includes a storage control processing unit (the accumulation processing unit F51) that performs a process of causing a storage device to store each piece of converted motion data obtained through the motion data conversion process performed on a plurality of movable objects in an interactive relation in a real space or a virtual space.

With this arrangement, it becomes possible to eliminate the need to perform motion capture using a high-precision motion capture system in obtaining high-quality motion data to be used for machine learning of a motion data inference model taking interactions between movable objects into consideration.

Thus, the machine learning of a motion data inference model taking interactions between movable objects into consideration can be performed at lower cost.

Further, an information processing method as an embodiment is an information processing method by which an information processing device receives an input of captured motion data that is motion data acquired with a motion capture system for a movable object, and performs a motion data conversion process to obtain motion data having a larger number of pieces of part data than the captured motion data, through a motion matching process based on the captured motion data or an inference process that uses an artificial intelligence model and uses the captured motion data as the input data.

By such an information processing method, it is possible to achieve functions and effects similar to those produced by the above-described information processing device as an embodiment.

Here, as an embodiment, a program for causing a processor such as a CPU to perform the processing performed by the motion data conversion unit F2 or F2A described above can be considered, for example.

That is, the program as an embodiment is a program that can be read by a computer device, and causes the computer device to implement a function of receiving an input of captured motion data that is motion data acquired with a motion capture system for a movable object, and performing a motion data conversion process to obtain motion data having a larger number of pieces of part data than that of the captured motion data, through a motion matching process based on the captured motion data or an inference process that uses an artificial intelligence model and uses the captured motion data as the input data.

With such a program, the functions as the motion data conversion unit F2 or F2A described above can be implemented in a device as the information processing device 1 or 1A, the server device 50, or the like.

The program described above can be recorded beforehand in an HDD as a recording medium built in a device such as a computer device, a ROM in a microcomputer having a CPU, or the like.

Alternatively, the program can also be temporarily or permanently stored (recorded) in a removable recording medium such as a flexible disk, a compact disc read only memory (CD-ROM), a magneto optical (MO) disk, a digital versatile disc (DVD), a Blu-ray Disc (registered trademark), a magnetic disk, a semiconductor memory, or a memory card. Such a removable recording medium can be provided as so-called packaged software.

Furthermore, such a program may be installed from the removable recording medium into a personal computer and the like, or may be downloaded from a download site through a network such as a local area network (LAN) or the Internet.

Furthermore, such a program is suitable for a wide range of provision of processing as embodiments. For example, the program is downloaded into a personal computer, a portable information processing device, a portable telephone, a game device, a video device, a personal digital assistant (PDA), or the like, so that the personal computer or the like can be made to function as a device that performs the processing as a motion data conversion unit of the present disclosure.

Note that, the effects described in the present specification are merely examples and are not restrictive, and some other effects may also be achieved.

### 6. Present Technology

The present technology may also adopt configurations as described below.
(1)

An information processing device including a motion data conversion unit that receives an input of captured motion data that is motion data acquired with a motion capture system for a movable object, and performs a motion data conversion process to obtain motion data having a larger number of pieces of part data than the captured motion data, through one of a motion matching process based on the captured motion data or an inference process that uses an artificial intelligence model and uses the captured motion data as input data.
(2)

The information processing device according to (1), in which the motion data conversion unit uses attribute information about the movable object in the motion data conversion process.
(3)

The information processing device according to (2), in which the motion data conversion unit uses static attribute information and dynamic attribute information as the attribute information.
(4)

The information processing device according to any one of (1) to (3),

in which the motion data conversion unit uses, in the motion data conversion process, information indicating a positional relationship between the movable object and another object.
(5)

The information processing device according to (4), in which the motion data conversion unit uses, in the motion data conversion process, information indicating a positional relationship between the movable object and another capture target movable object.
(6)

The information processing device according to (4) or (5),

in which the motion data conversion unit uses, in the motion data conversion process, information indicating a positional relationship between the movable object and another specific object.
(7)

The information processing device according to any one of (1) to (6), further including

a motion data adjustment unit that adjusts motion data newly obtained through the motion data conversion process, on the basis of immediately preceding output motion data.
(8)

The information processing device according to (7), in which the motion data adjustment unit adjusts motion data of a finger of the movable object newly obtained through the motion data conversion process, on the basis of immediately preceding output motion data of the finger and a velocity of a hand of the movable object.
(9) The information processing device according to any one of (1) to (8),
in which the motion data conversion unit performs the motion data conversion process through the motion matching process, and feeds back position information about tips of fingers of the movable object to an input for the motion matching process, the position information having been obtained through an immediately preceding motion data conversion process.
(10)

The information processing device according to (9),
in which the motion data conversion unit feeds back, to the input for the motion matching process, only position information about a tip of a thumb and a tip of an index finger among the position information about the tips of the fingers of the movable object obtained through the immediately preceding motion data conversion process.
(11)

The information processing device according to any one of (1) to (10), further including

a storage control processing unit that performs a process of causing a storage device to store converted motion data obtained through the motion data conversion process for each movable object among a plurality of the movable objects having an interactive relation in one of a real space or a virtual space.
(12)

An information processing method implemented by an information processing device,

the information processing method including receiving an input of captured motion data that is motion data acquired with a motion capture system for a movable object, and performing a motion data conversion process to obtain motion data having a larger number of pieces of part data than the captured motion data, through one of a motion matching process based on the captured motion data or an inference process that uses an artificial intelligence model and uses the captured motion data as input data.
(13)

A program readable by a computer device, the program causing the computer device to implement a function of

receiving an input of captured motion data that is motion data acquired with a motion capture system for a movable object, and performing a motion data conversion process to obtain motion data having a larger number of pieces of part data than the captured motion data, through one of a motion matching process based on the captured motion data or an inference process that uses an artificial intelligence model and uses the captured motion data as input data.

### REFERENCE SIGNS LIST

1, 1A Information processing device
2 Sensor device
Ob Movable object
11, 11A Processor unit
F1 Motion data acquisition unit
F2, F2A Motion data conversion unit
F20 Retargeting unit
F21 Motion matching unit
F3 Motion data adjustment unit
30 Motion data table group
30a Motion data table
F22 Trained AI model
L22, L25 Learning machine
L22a, L25a Gating network
L22b, L25b Motion network
50 Server device
51 User terminal
52 Display device
NT Network
F50 Virtual space information generation unit
F51 Accumulation processing unit
F52 Rendering unit

1. An information processing device comprising a motion data conversion unit that receives an input of captured motion data that is motion data acquired with a motion capture system for a movable object, and performs a motion data conversion process to obtain motion data having a larger number of pieces of part data than the captured motion data, through one of a motion matching process based on the captured motion data or an inference process that uses an artificial intelligence model and uses the captured motion data as input data.

2. The information processing device according to claim 1,
wherein the motion data conversion unit uses attribute information about the movable object in the motion data conversion process.

3. The information processing device according to claim 2,
wherein the motion data conversion unit uses static attribute information and dynamic attribute information as the attribute information.

4. The information processing device according to claim 1,
wherein the motion data conversion unit uses, in the motion data conversion process, information indicating a positional relationship between the movable object and another object.

5. The information processing device according to claim 4,
wherein the motion data conversion unit uses, in the motion data conversion process, information indicating a positional relationship between the movable object and another capture target movable object.

6. The information processing device according to claim 4,
wherein the motion data conversion unit uses, in the motion data conversion process, information indicating a positional relationship between the movable object and another specific object.

7. The information processing device according to claim 1, further comprising
a motion data adjustment unit that adjusts motion data newly obtained through the motion data conversion process, on a basis of immediately preceding output motion data.

8. The information processing device according to claim 7,
wherein the motion data adjustment unit adjusts motion data of a finger of the movable object newly obtained through the motion data conversion process, on a basis of immediately preceding output motion data of the finger and a velocity of a hand of the movable object.

9. The information processing device according to claim 1,
wherein the motion data conversion unit performs the motion data conversion process through the motion matching process, and feeds back position information about tips of fingers of the movable object to an input for the motion matching process, the position information having been obtained through an immediately preceding motion data conversion process.

10. The information processing device according to claim 9,
wherein the motion data conversion unit feeds back, to the input for the motion matching process, only position information about a tip of a thumb and a tip of an index finger among the position information about the tips of the fingers of the movable object obtained through the immediately preceding motion data conversion process.

11. The information processing device according to claim 1, further comprising
a storage control processing unit that performs a process of causing a storage device to store converted motion data obtained through the motion data conversion process for each movable object among a plurality of the movable objects having an interactive relation in one of a real space or a virtual space.

12. An information processing method implemented by an information processing device,
the information processing method comprising
receiving an input of captured motion data that is motion data acquired with a motion capture system for a movable object, and performing a motion data conversion process to obtain motion data having a larger number of pieces of part data than the captured motion data, through one of a motion matching process based on the captured motion data or an inference process that uses an artificial intelligence model and uses the captured motion data as input data.

13. A program readable by a computer device, the program causing the computer device to implement a function of
receiving an input of captured motion data that is motion data acquired with a motion capture system for a movable object, and performing a motion data conversion process to obtain motion data having a larger number of pieces of part data than the captured motion data, through one of a motion matching process based on the captured motion data or an inference process that uses an artificial intelligence model and uses the captured motion data as input data.
